(19) United States
(12) Patent Application Publication
(10) Pub. No.: US 2005/0033618 A1
(43) Pub. Date: Feb. 10, 2005

(54) Real estate products and services marketing method

(76) Inventor: Rusty Rexius, Springfield, OR (US)

Correspondence Address: Robert W. Connors, Esq.;Bell, Boyd & Lloyd LLC, P.O. Box 1135, Chicago, IL, 60690-1135, US

(21) Appl. No.: 10/637,270

(22) Filed: Aug. 8, 2003

(51) Int. Cl. G06F 17/60

(52) U.S. Cl. 705/7

(57) ABSTRACT

A real estate products and services marketing method is provided. In one embodiment, a real estate improvement provider coordinates with a realtor to provide the improvement and to defer payment from the seller for the improvement until close of the seller's real estate. In another embodiment, the improvement provider coordinates with a lender to provide the improvement and to defer payment from the borrower until close of the loan. In a further embodiment, a realtor identifies needed improvements in seller's real estate and locates an appropriate improvement provider(s), wherein payment for the improvement(s) is deferred until close of the seller's real estate. In still another embodiment, a lender identifies needed improvements in borrower's real estate and locates an appropriate improvement provider(s), wherein payment for the improvement(s) is deferred until close of the loan. It is expected that the increase in sales price/loan amount exceeds the cost of the improvement.

### BACKGROUND OF THE INVENTION

The present invention relates to real estate and more particularly to the marketing of real estate improvement products and services as well as to the sale of real estate, financing of real estate and providing loans using real estate as collateral. Real estate can be sold or used as collateral for a loan, as is well known. In those endeavors, it is desirable for the seller to obtain as high a sales price as possible and for borrowers to be able to borrow as much as possible. In either case it is desirable for the seller/borrower to maintain and present the real estate in as good a condition as possible.

Many people are reluctant to make substantial improvements to their real estate prior to its sale. People question whether it is wise to make an improvement that someone else, namely the buyer, will get to enjoy. Those people in many cases decide that it is wiser to use the money it would have cost to make the improvement as part of a down payment or improvement of the seller's next piece of property.

Many people fail to realize and therefore capitalize on the fact that the cost of making an improvement to one's real estate is less and perhaps substantially less than the increased sales price amount gained due to the improvement. Likewise, the cost of making an improvement to one's real estate is in many cases less and perhaps substantially less than the increased loan amount a borrower can receive due to the improvement.

Recent estimations have stated that the typical recovery by home sellers for landscaping projects to be between one hundred to two hundred percent, kitchen remodeling to between seventy-five and one hundred twenty-five percent and bathroom remodeling to be between twenty to one hundred twenty percent (http//www.startribune.com/stories/1664/3892190.html). Another source states that a well-landscaped yard with mature trees can increase a home's value by twenty percent (Associated Landscape Contractors of America). Indeed, projects such as planting trees, rock walls, gardens and native planting can add four to five percent to the selling price of an average home ($250,000 and less) according to a 2001 survey of the National Association of Realtors (http://www.startribune.com/stories/836/3892187.html).

There is of course a certain amount of risk in making an improvement to one's real estate, which can cost thousands of dollars. There is no guarantee that the seller will recoup the cost of the improvement. Moreover, the money for the improvement is due upon completion of the service or delivery of the product, which may occur at a time substantially sooner (on the order of months) than the ultimate sale of the home. The appraisal process lessens the risk of not obtaining a higher loan amount based on an improvement made to one's real estate. Nevertheless, the fear of the inherent risk of spending money on real estate improvements and the lack of knowledge as to the potential gains that can be made by such improvements are restricting the real estate improvement market, at least with respect to making such improvements prior to a sale of the real estate or for a loan using the real estate as collateral. A need, therefore, exists for a method of reducing or avoiding those restricting factors.

### SUMMARY OF THE INVENTION

The present invention addresses the above-described factors limiting real estate improvements, which would otherwise place the real estate in a better condition for sale or financing. In particular, a program, referred to herein as the Real Estate Improvement program, is implemented in which either an improvement provider, a separate Real Estate Improvement program-representative, the real estate agent or a real estate lender, informs a real estate seller or borrower of the potential gains that can be made if one or more improvements to the real estate is made. If the seller/borrower agrees to have the work performed or product installed, the payment for that work/product is deferred until the time of close of the sale or the loan. If the sale or loan proceeds to close as contracted, the seller/borrower does not have to write a check, etc., for the work because the cost is deducted from the proceeds of the sale or loan. Assuming the real estate sells for more than the cost of the improvement, the seller makes money with no out-of-pocket expense.

The Real Estate Improvement program stands to potentially benefit everyone involved in a real estate transaction. In one aspect, the program provides an avenue for real estate products and service providers to market their respective products and services. For example, a real estate improvement provider can coordinate with realtors to provide real estate improvements and defer acceptance of payment for the improvements until close of the sale of real estate. The improvement provider can alternatively coordinate with lenders to provide real estate improvements and defer payment until close of the loan. While payment is deferred, the real estate improvement market is increased. The proceeds of the closings also provide relatively safe source of revenue for the improvement providers.

In another aspect, the program provides an avenue for a realtor or a real estate lender to increase the sales price or loan amount for the real estate. A realtor after visiting a piece of real estate for potential sale can identify one or more possible needed improvements that will likely increase the sales price of the real estate above and beyond the cost of the improvement. If the seller agrees, the realtor locates one or more improvement providers to perform the work, wherein payment for the work is deferred until close of the seller's real estate. The sales price of the real estate likely increases as does the realtor's commission.

In a similar manner, a real estate lender can talk with a borrower and identify one or more improvements in the borrower's real estate that will likely increase the appraisal value of the real estate. An appraiser can be contacted to provide an estimated appraisal value for the improved property. If the seller agrees, the lender locates one or more improvement providers to perform the work, wherein payment for the work is deferred until close of the loan. The loan amount increases as does the lender's commission for the loan.

The seller/borrower also benefits from the Real Estate Improvement program. The seller can make more money from the sale of the real estate via one or more improvements. Payment for such improvements is deferred and is somewhat invisible to the seller in that the payment appears merely as a line item on the closing documents. The seller can potentially make money with no out-of-pocket expenses In a similar manner, the borrower is able to obtain a higher loan amount and defer payment for the improvement until close. Payment appears as a line item in the closing documents, so that no money has to be paid for the improvement by the borrower from a bank account or the like.

The real estate improvements include products and services. In one embodiment, the services provided are landscaping services, such as seeding, mulching, hedging, berm building, waterfall and/or pond installation, planting of trees and shrubbery, etc. In another embodiment, the services include painting, remodeling, plumbing, roofing, tarring, paving, brick, stone or gravel laying, deck installation, swimming pool installation and any combination of those. Those services inherently include products. Other products include windows, doors, drainage equipment, siding, hardwood flooring and carpeting. Likewise, those products also include installation and other types of services. Remodeling and home additions are also included. Longer lead time improvements, such as remodeling/additions, may require the sale of the home or the close of the loan to be delayed. The majority of the services and products, however, can be completed or delivered within a timeframe that does not significantly delay the sale or loan process.

The product or service improvement provider maintains certain safeguards in the event that the real estate sale or loan transaction is not completed as planned. For example, the improvement provider can obtain an authorized credit card slip from the seller or borrower upon performing the work or providing the service. If the seller pulls the real estate off the market, changes agents, or is not able to sell the real estate within a contracted timeframe, the improvement provider submits the authorized credit card slip for payment. In a similar manner, if the borrower forgoes the loan, changes lenders, fails to be approved for the loan (although approval would likely be given before improvement is provided) or for any other reason the loan is not transacted within a specified timeframe, the improvement provider submits an authorized credit card slip from the borrower for payment.

In one embodiment, the methods described herein are embodied in a computer program stored on a computer storage device, a data network or an internet.

It is therefore an advantage of the present invention to provide a method for marketing home improvement products and services.

It is another advantage of the present invention to provide a method for selling real estate.

It is a further advantage of the present invention to provide a method for transacting a real estate loan.

It is still a further advantage of the present invention to enable a real estate seller to increase profits made on the sale of real estate.

Moreover, it is an advantage of the present invention to enable a borrower using real estate as collateral to obtain a higher loan amount.

Still further, it is an advantage of the present invention to increase the market for home improvement products and services.

Yet further, it is an advantage of the present invention to increase a real estate sales price and therefore a commission therefrom for realtors.

Still another advantage of the present invention is to increase real estate loan amounts and therefore a commissions therefrom for real estate lenders.

Additional features and advantages of the present invention are described in, and will be apparent from, the following Detailed Description of the Invention and the figures.

### BRIEF DESCRIPTION OF THE FIGURES

FIG. 1 is a process flow diagram for one embodiment of the present invention, wherein a product or service provider markets a respective product or service through the sale of real estate.

FIG. 2 is a process flow diagram of another embodiment of the present invention, wherein the product or service provider markets a respective product or service through a loan using the borrower's real estate as collateral.

FIG. 3 is a process flow diagram of a further embodiment of the present invention, wherein a realtor uses real estate improvement products or services to help sell a piece of real estate.

FIG. 4 is a schematic flow diagram of yet another embodiment of the present invention, wherein a lender uses a real estate improvement products or services to help transact a loan using real estate as collateral.

### DETAILED DESCRIPTION OF THE INVENTION

The present invention includes a program, referred to herein as the Real Estate Improvement program, which increases real estate improvement sales, increases real estate sales prices and increases the amount of money real estate owners can borrow against their real estate. “Real estate” as used herein refers to land without dwellings, land with dwellings, residential structures, commercial structures, condominiums, apartment buildings and any other parcel of land or structure that is included under that term.

Real estate “improvement” as used herein refers to any product, service or combination thereof that can improve the value of real estate, including but not limited to, landscaping (including sod laying, seeding, mulching, edging, grading, leveling or berm building, weeding, planting of trees, shrubs or plants/flowers, installation of ponds, waterfalls, rock walls or sprinkler systems), interior or exterior painting, wallpapering, siding or installation of stucco, brick or stone exterior or interior walls, hardwood or other type of flooring, installing, repairing or replacing fireplaces, carpeting, tiling, remodeling or home additions (including separate dwellings such as coach houses or detached garages), plumbing, roofing, tuck pointing, window replacement, installation or repair, pest control, drainage equipment installation or repair, installation of a Jacuzzi, whirlpool or hot tub, replacement or new installation of fixtures, upgrading vanities, toilets, bathroom or kitchen countertops, decking replacement, repair or installation, driveway/walkway installation, repair or replacement, and any combination thereof.

“Realtor” as used herein refers to a real estate agent, broker, representative or any other type of realtor. “Lender” as used herein refers to a real estate lending agent, broker, representative of a bank or mortgage company or any other type of lender. Real Estate Improvement representative as used herein means anyone authorized to use or communicate the Real Estate Improvement Program, including the improvement provider, realtor, lender or a separate authorized agent.

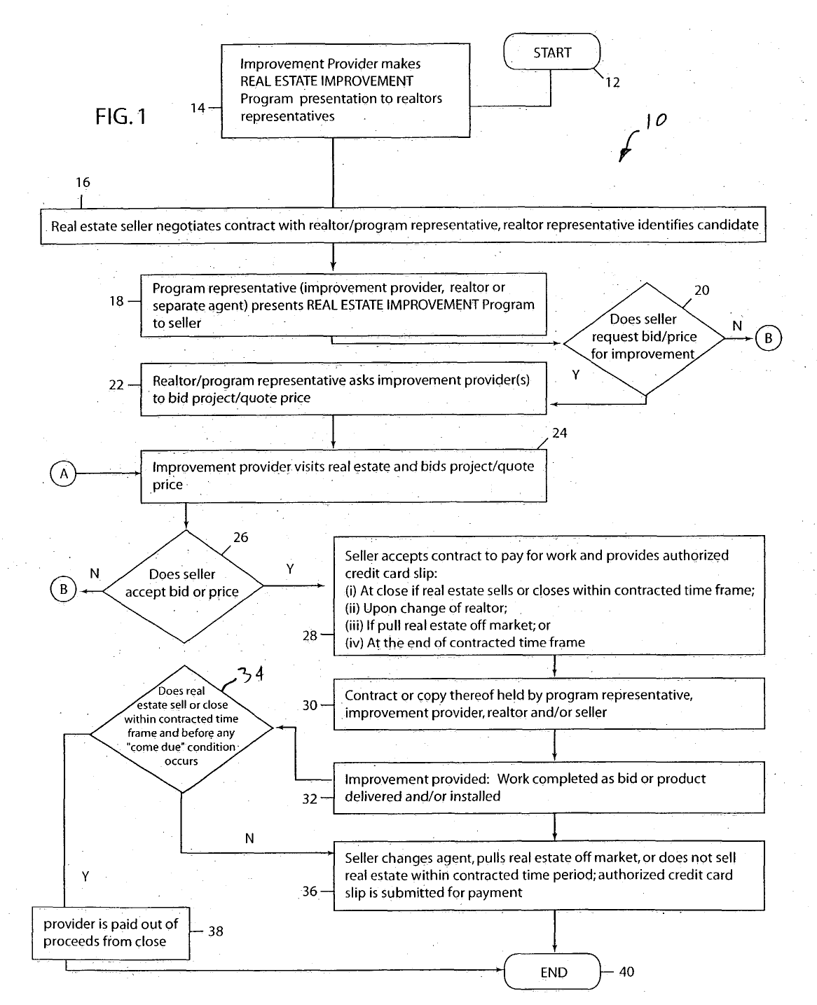

Referring now to the drawings and in particular to FIG. 1, a method 10 for marketing a real estate improvement is illustrated. Upon starting method 10, as indicated by oval 12, an improvement company makes a Real Estate Improvement program presentation to one or more realtors, as indicated by block 14. For example, an improvement company representative visits a real estate office, wherein the representative talks to and discloses the program to multiple realtors at once. If the realtors agree, they become Real Estate Improvement representatives. The presentation can occur at a local, regional or national level.

An improvement provider representative, a realtor or both can market the program. That is, the provider, the realtor, or both parties can endeavor to identify real estate sellers as potential candidates for the Real Estate Improvement program, as indicated by block 16. The Real Estate Improvement program can also be advertised in newspapers, television/radio ads, in home improvement stores, etc. Afterward, either or both the realtor or the improvement provider presents the Real Estate Improvement program to the seller, as indicated by block 18.

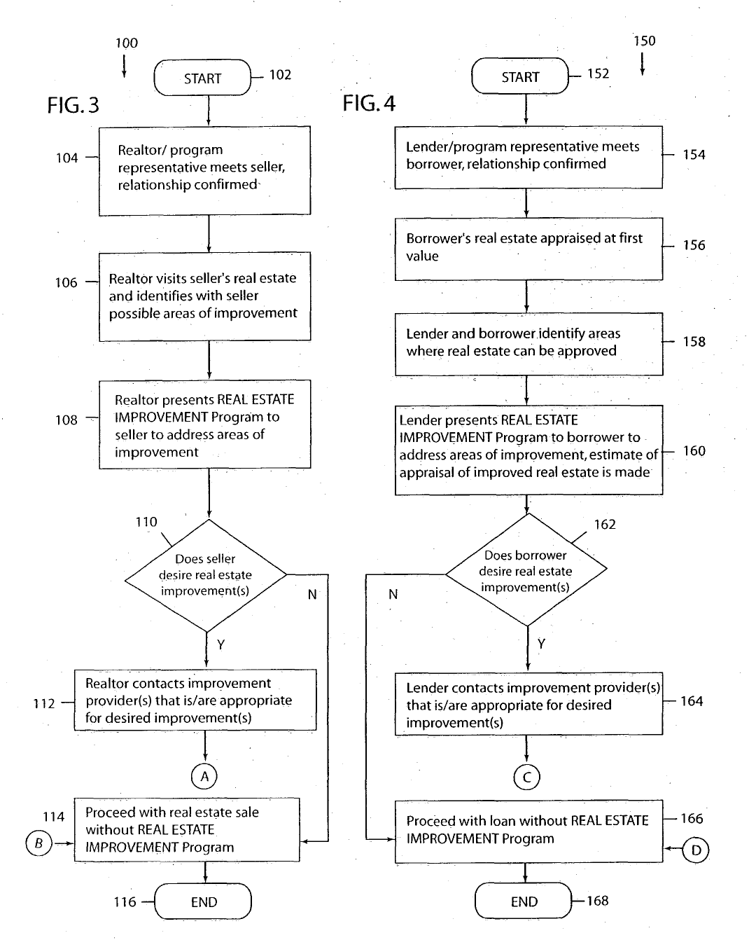

If the seller decides to request a bid or price for the improvement, as indicated by a positive response to diamond 20, the realtor asks the improvement provider to bid on the project or quote a price for the improvement, as indicated by block 22. The improvement provider visits the real estate and bids the project or quotes the price, as indicated by block 24. If the seller does not wish to receive a bid or quote for improvement, as indicated by a negative response to diamond 20, the realtor proceeds with the real estate sale without the Real Estate Improvement program, as indicated by block 114 of FIG. 3.

After the seller receives the bid or price, the seller can accept or reject the bid or price, as indicated by diamond 26. If the seller rejects the bid or price, the realtor proceeds with the sale without the Real Estate Improvement program, as indicated by block 114 of FIG. 3. In an alternative embodiment (not illustrated), the realtor upon approval by the seller can seek to find a different improvement provider to provide a different price or quote. Further alternatively, the disclosure of blocks 22 and 24 can be expanded to include having multiple Real Estate Improvement representatives, who are in competition with one another, bid on the improvement. The seller receives a number of quotes and can either choose one of the quotes or decide not to have the work performed. When the Real Estate Improvement representative is not the actual provider of the improvement, e.g., is the realtor or separate agent, the representative maintains a list of providers and requests quotes from the providers as necessary. FIG. 3 illustrates one embodiment where the realtor is also the Real Estate Improvement program representative.

If the seller does accept the bid or price for the improvement, the seller accepts, as indicated in block 28, a contract to pay for the work, either: (i) at close if the real estate sells within contracted time frame; (ii) upon seller's change of realtors; (iii) upon seller pulling the real estate off the market; or (iv) at the end of a contracted time period.

The contract discussed in connection with block 28 is between the seller and either the improvement provider, the realtor or the Real Estate Improvement program representative. In any case, the contract calls for a time period in which the seller's real estate must be sold for the improvement to be paid for from the proceeds of the sale. The time period in one embodiment is based on the close of the sale of the real estate, which makes irrelevant whether or not the seller's contract is a contingent contract (e.g., contingent upon buyer's close). In an alternative embodiment, the Real Estate Improvement program contract can call for a milestone, such as the seller entering into a contract with a buyer, contingent or otherwise, within a specified period of time. The milestone would provide the improvement provider with an option to demand payment from the seller if the seller does not obtain a contract within the time period.

The time period specified for close can be any suitable period of time, such as one month to nine months. The contract can also provide for extensions of time (e.g., to extend the close or milestone period), which are granted or not granted by the improvement provider for example based on sales activity, a number of offers received/rejected by the seller, or for example, the improvement provider's perception that the seller's asking price is too high.

The contract does not bind the seller to accept an offer that the seller does not wish to accept or force the seller to sell within an accelerated period of time. Instead, the seller agrees to pay for the service or goods at the end of the contracted time period. If the seller wishes to maintain the real estate on the market past the contracted time period, the seller pays the improvement provider or the Real Estate Improvement program representative and proceeds with the sale in a normal manner.

Block 28 also illustrates that the contract can contain a number of other conditions, i.e., “come-due” conditions, upon which payment for the improvement becomes due. For example, if the seller pulls the real estate off of the market, the seller must pay for the improvement at that time. Likewise, if the seller changes realtors and the contract is tied to or includes as a party the old realtor, the seller must pay for the improvement at the time of the change in one embodiment. If the contract is solely between the improvement provider and the seller or between a Real Estate Improvement representative that represents the improvement provider but not the realtor, the contract may remain in force even upon change of the seller's realtor. In such a case, the contract can include certain assurances to the improvement provider, such as the seller's showing of diligence in retaining another realtor within a specified time period.

A copy of the contract is kept with at least one of: the Real Estate Improvement program representative, improvement provider (if different), the realtor (if different) and the seller as indicated by block 30. The contract can be attached as an addendum to the buyer/seller contract or be incorporated into other papers signed by the seller for the realtor. The improvement is then provided as bid or quoted, as indicated by block 32. The improvement includes any of the services and/or products described above. Although not illustrated, the Real Estate Improvement contract can include provisions to ensure that the improvement is provided properly and timely.

If the real estate sells within the contracted time period and before any “come-due” condition occurs, as indicated by diamond 34, the improvement provider is paid out of the proceeds from the close of sale, as indicated by block 38. In one embodiment, the cost of the improvement appears as a line item in the closing documents. That is, the seller's closing documents show the amount of proceeds from the sale less any remaining mortgage on the real estate and other costs. The cost of the improvement appears as one of those other costs. The title company in one embodiment writes a check to the improvement provider or to the Real Estate Improvement representative, who if different than the improvement provider pays in turn the amount owed to the improvement provider.

If the selling price of the real estate is increased by an amount that is more than the cost of the improvement(s), then each of the parties involved in the transaction obtains a benefit. The improvement provider obtains a sale of goods or services. The real estate seller receives an increased profit from the transaction. The realtor receives an increased commission for the sale of the real estate at the higher selling price. The realtor in one embodiment also receives a portion of the amount paid for the improvement. After the provider is paid out of the proceeds of close, as indicated by block 38, the method 10 of the present invention ends as indicated by oval 40.

If the real estate does not sell within the contracted time frame or one of the come-due conditions of block 28 occurs, as indicated by diamond 34, the seller pays for the improvement as indicated by block 36. That is, if the seller changes agents, pulls the real estate off the market or does not sell the real estate within the contracted time period, a payment is automatically made. In one embodiment, at or around the time of execution of the Real Estate Improvement program contract, the seller provides a signed credit card receipt to the improvement provider, real estate agent or Real Estate Improvement representative. That signed credit card authorization is not redeemed for payment unless one of the conditions in block 36 occurs. The authorization is destroyed if close occurs on time. The improvement provider receives money for the work performed or products provided and the method ends as indicated by oval 40. Although not illustrated, if the “come-due” condition is the passing of the time period without a sale or close of the real estate, the realtor and seller can continue to market the improved real estate without the Real Estate Improvement program as indicated by block 114 of FIG. 3.

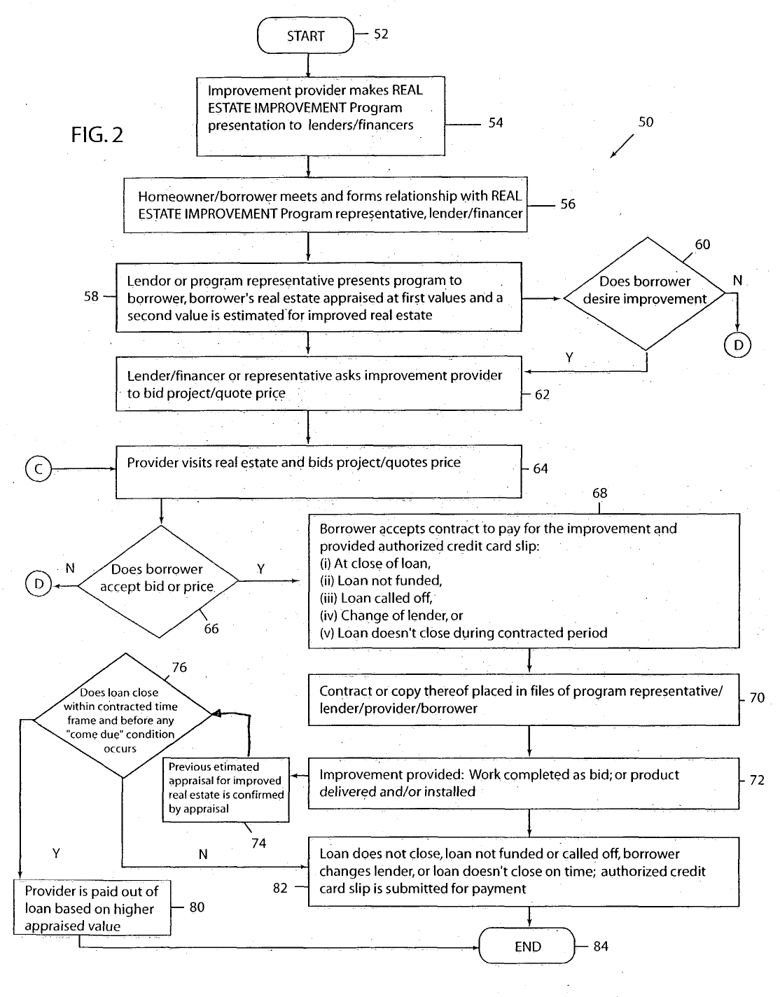

Referring now to FIG. 2, an alternative method 50 illustrates a similar sequence to the method 10 of FIG. 1, but instead is set in the context of a loan based on real estate, such as a home equity loan, a refinance or a second or additional mortgage. Upon starting method 50 as indicated by Oval 52, the improvement provider (or other Real Estate Improvement program representative) makes a Real Estate Improvement program presentation to a lender(s) or financier(s) as indicated by block 54. Those lenders or financiers may in turn become Real Estate Improvement program representatives.

A homeowner or borrower next meets and forms a relationship with the representative, lender or financier, as indicated by block 56. The borrower's real estate is appraised at a first value, whereupon the lender/representative presents the Real Estate Improvement program to the borrower as indicated by block 58. As part of the presentation, an estimated appraised value of the improved real estate is made based upon one or more improvements. The original and improved appraisals establish a lower and higher maximum amount that the borrower can borrow. If the borrower does not desire an improvement, as indicated by diamond 60, the loan proceeds without the Real Estate Improvement program, as indicated by block 166 of FIG. 4.

If the borrower does desire an improvement, as indicated by diamond 60, the representative, lender or financier asks a Real Estate Improvement representative to bid on the project or quote a price, as indicated by block 62. The improvement provider visits the real estate and bids the project or quotes the price as indicated by block 64. As before, the borrower can receive multiple bids or quotes. If the borrower does not accept the bid(s) or price(s), as indicated by diamond 66, the loan proceeds without the Real Estate Improvement program, as indicated by block 166 of FIG. 4.

If the borrower does accept the bid or price as indicated by diamond 66, a contract is formed, as indicated by block 68. The contract may be between the borrower and the provider, lender or Real Estate Improvement representative, if different. The contract may be provided as an addendum to the loan documents. The borrower accepts in the contract to pay for the improvement: (i) at and through the close of the loan; (ii) upon demand if the loan is for whatever reason not funded or not approved; (iii) upon demand if the borrower calls off the loan; (iv) upon demand if the borrower changes lenders (e.g., if the lender is part of the contract); or (v) upon demand if the loan does not close during a contracted period, as indicated by block 68. In most instances, approval for the loan should be given before the Real Estate Improvement contract is executed.

The contract, or a copy thereof, is placed in one or more file(s) with the Real Estate Improvement program representative, the lender, provider and/or borrower, as indicated by block 70. The improvement is then provided to the lender, which includes completing work as bid and/or providing a product as quoted and/or installing same, as indicated by block 72. Any of the products or services listed above is applicable in connection with method 50. The contract may again include clauses that protect the borrower against faulty work or products or untimely performance.

A second appraisal is performed based on the improved real estate to confirm the previous estimated appraisal for improved real estate, as indicated by block 74. The new appraisal is very likely to be higher and perhaps substantially higher than the first appraisal and will most likely equal or exceed the estimate. The new appraisal made in connection with block 74 also ensures that the improvement has been installed properly and/or works satisfactorily.

If the loan closes within the contracted time frame and before any “come-due” condition occurs, as indicated by diamond 76, the provider is paid out of the proceeds of the loan, which loan is based on the higher appraised value, as indicated by block 80. The improvement provider is paid in a similar manner to the payment in method 10, namely, out of proceeds transferred at close of the home improvement loan, refinance or second mortgage. The loan documents reflect as a line item the costs of the improvement. The lending company or title company writes a check (or wire transfer) to the improvement provider or to the Real Estate Improvement program representative, who in turn pays the improvement provider. Upon payment for the improvement and the disbursement of the loan proceeds, the method 50 ends, as indicated by oval 84.

If the loan closes on time, the improvement provider benefits because the provider increases its market share due to the work generated by the Real Estate Improvement program. The borrower benefits because the borrower is able to obtain a higher loan amount and also has improved real estate. The lender benefits because the lender's-commission is based on a higher loan amount. The lender in one embodiment also receives a portion of the proceeds from of the improvement.

If the loan does not close within a contracted time frame or one of the other “come-due” conditions occurs, as indicated by diamond 76, the borrower pays the improvement provider automatically, as indicated by block 82. That is, if the loan does not close or is not approved, the borrower calls off the loan, the borrower changes lenders or the loan does not close on time, an automatic payment is made. As before, one preferred method of automatically receiving payment is to receive an authorized credit card slip from the borrower at the time of contracting, wherein that authorized slip is held until one of the conditions set forth in block 82 occurs. If the loan does close on time, the slip is destroyed. Afterward, the method 50 ends as indicated by oval 84.

Referring now to FIG. 3, a method 100 for marketing real estate is illustrated. Upon starting the method as indicated by oval 102, a realtor, who may also be an authorized Real Estate Improvement program representative, meets a seller and forms a relationship with same, as indicated by block 104. The realtor visits the seller's real estate and during the course of inspecting the real estate identifies one or more possible areas of improvement as indicated by block 106.

Upon identifying possible improvements, the realtor or program representative presents the Real Estate Improvement program to the seller to address the areas of improvement, as indicated by block 108. To remedy the areas of improvement, any of the products and/or services described previously may be discussed and/or sought.

If the seller does not desire the real estate improvements suggested by the realtor, as indicated by diamond 110, the sale of the seller's real estate proceeds without the Real Estate Improvement program, as indicated by block 114, and the method ends, as indicated by oval 116. If the seller does desire one or more of the real estate improvements suggested by the realtor/Real Estate Improvement program representative, the realtor contacts one or more improvement providers (who may also be Real Estate Improvement program representatives) appropriate for the desired one or more improvements, as indicated by block 112.

Because the realtor in one embodiment is also a Real Estate Improvement program representative, the realtor is authorized to call various improvement providers directly to receive a quote or bid from the providers. In one embodiment, the improvement providers must be Real Estate Improvement program representatives or otherwise authorized under the program. The realtor may contact for quote or bid more than one provider for the same improvement. In an alternative embodiment, the realtor contacts a separate Real Estate Improvement program representative, who in turn contacts one or more of the improvement providers. In any case, the method 100 proceeds to the step of block 24 of method 10, wherein one or more improvement provider visits the real estate and bids the project or quotes a price. Method 100 then incorporates each of the steps remaining in method 10.

Referring now to FIG. 4, a method 150 for providing a loan based on real estate collateral is illustrated. Upon starting the method as indicated by oval 152, a lender who may also be an authorized Real Estate Improvement program representative, meets a borrower and forms a relationship with same, as indicated by block 154. The lender has the borrower's real estate appraised at a first value, as indicated by block 156. The lender and borrower then attempt to identify one or more areas to improve the appraisal value of the home, as indicated by block 158.

Upon identifying possible improvements, the lender/representative presents the Real Estate Improvement program to the borrower to address the areas of improvement, as indicated by block 160. To remedy the areas of improvement, any of the products and/or services described previously may be discussed or sought. The lender/financier can also make an estimate of an appraisal for the real estate as improved to establish different maximum loan amounts.

If the borrower does not desire the real estate improvements suggested by the lender, as indicated by diamond 162, the loan based on the borrower's real estate proceeds without the Real Estate Improvement program, as indicated by block 166, and the method ends, as indicated by oval 168. If the borrower does desire one or more of the real estate improvements suggested by the lender, the lender/Real Estate Improvement program representative contacts one or more improvement providers (who may have to be authorized by the Real Estate Improvement program) appropriate for the desired one or more improvements as indicated by block 164.

Because the lender in one embodiment is also a Real Estate Improvement representative, the lender is authorized to call various improvement providers directly to receive a quote or bid from the providers. The lender may contact more than one provider for the same improvement. In an alternative embodiment, the lender contacts a Real Estate Improvement program representative, who in turn contacts one or more of the improvement providers. In any case, the method 150 then proceeds to the block 64 of method 50, wherein one or more improvement provider visits the real estate and bids the project or quotes a price. Method 150 then incorporates each of the steps remaining in method 50.

In one embodiment, the teachings of the present invention are embodied in a computer program stored on a computer storage device, a data network or an internet.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A real estate improvement marketing method comprising the steps of:
(a) making an improvement available to a real estate owner who is intending to sell his/her real estate; and
(b) entering a contract with the owner, wherein the owner receives the improvement and agrees to pay for the improvement out of proceeds from a sale of the real estate.

2. The real estate improvement marketing method of claim 1, which includes the step of providing the improvement.

3. The real estate improvement marketing method of claim 1, which includes collecting a payment for the improvement upon the sale of the real estate.

4. The real estate improvement marketing method of claim 3, which includes collecting the payment from a title company that closes the sale of the real estate.

5. The real estate improvement marketing method of claim 3, which includes collecting the payment from a realtor associated with the sale of the real estate.

6. The real estate improvement marketing material of claim 1, wherein the contract further requires the owner to pay for the improvement from another source of funds if the real estate does not sell in a specified time period.

7. The real estate improvement marketing method of claim 1, wherein the contract further requires the owner to pay for the improvement from another source of funds if the owner stops offering the real estate for sale.

8. The real estate improvement marketing method of claim 1, wherein the contract further requires the owner to pay for the improvement from another source of funds if the owner changes realtors.

9. The real estate improvement marketing method of claim 1, wherein the improvement is selected from the group consisting of: landscaping (including sod laying, seeding, mulching, edging, grading, leveling or berm building, weeding, planting of trees, shrubs or plants/flowers, installation of ponds, rock walls, waterfalls or sprinkler systems), interior or exterior painting, wallpapering, siding or installation of stucco, brick or stone exterior or interior walls, installing hardwood or other type of flooring, installing, repairing or replacing fireplaces, carpeting, tiling, remodeling or home additions (including separate dwellings such as coach houses or detached garages), plumbing, roofing, tuck pointing, window replacement, installation or repair, pest control, drainage equipment installation or repair, installation of a Jacuzzi, whirlpool or hot tub, replacement or new installation of fixtures, upgrading vanities, toilets, bathroom or kitchen countertops, decking replacement, repair or installation, driveway/walkway installation, repair or replacement, and any combination thereof.

10. The real estate improvement marketing method of claim 1, which includes making the improvement available to the owner via advertising.

11. The real estate improvement marketing method of claim 1, which includes making the improvement available to the owner via a realtor.

12. The real estate improvement marketing method of claim 1, which includes the step of presenting steps (a) to (b) to a realtor who then perfomms step (a).

13. The real estate improvement marketing method of claim 1, wherein entering a contract with the owner includes contracting between a provider of the improvement and the owner.

14. The real estate improvement marketing method of claim 1, wherein entering a contract with the owner includes contracting between a realtor and the owner.

15. The real estate improvement marketing method of claim 1, which is provided via a computer program on a computer storage device, data network or internet.

16. A real estate improvement marketing method comprising the steps of:
(a) estimating an amount of additional money a real estate owner can make through a sale of real estate if a real estate improvement is provided prior to the sale;
(b) quoting a price to the owner for the improvement that is below the amount; and
(c) subtracting the quoted price from proceeds of the sale.

17. The real estate improvement marketing method of claim 16, which includes contracting with the owner and a provider of the improvement, wherein the provider receives the subtracted proceeds.

18. The real estate improvement marketing method of claim 16, wherein a provider of the improvement receives the subtracted proceeds.

19. The real estate improvement marketing method of claim 16, which includes the step of contracting with the owner and a realtor to provide for the improvement.

20. The real estate improvement marketing method of claim 19, which includes the further step of contracting between the realtor and a provider of the improvement.

21. The real estate improvement marketing method of claim 16, wherein the realtor receives the subtracted proceeds.

22. The real estate improvement marketing method of claim 21, wherein the realtor pays at least a portion of the subtracted proceeds to a provider of the improvement.

23. The real estate improvement marketing method of claim 16, which is provided via a computer program on a computer storage device, data network or internet.

24. A real estate improvement marketing method comprising the steps of:
(a) estimating an amount of money an owner can borrow via a loan using real estate as collateral if a real estate improvement is provided prior to the loan;
(b) quoting a price to the owner for the improvement that is below the amount; and
(c) subtracting the quoted price from proceeds of the loan.

25. The real estate improvement marketing method of claim 24, which includes contracting with the owner and a provider of the improvement, wherein the provider receives the subtracted proceeds.

26. The real estate improvement marketing method of claim 24, wherein a provider of the improvement receives the subtracted proceeds.

27. The real estate improvement marketing method of claim 24, which includes the step of contracting with the owner and a lender to provide for the improvement.

28. The real estate improvement marketing method of claim 24, which includes the further step of contracting between the lender and a provider of the improvement.

29. The real estate improvement marketing method of claim 24, wherein the lender receives the subtracted proceeds.

30. The real estate improvement marketing method of claim 29, wherein the lender pays at least a portion of the proceeds to a provider of the improvement.

31. The real estate improvement marketing method of claim 24, which is provided via a computer program on a computer storage device, data network or internet.

32. A landscaping service/product marketing method comprising the steps of:
(a) making a landscaping service/product available to a real estate owner;
(b) contracting with the owner to provide the service/product, wherein the owner agrees to pay for the service/product out of the proceeds from a sale of the real estate;
(c) providing the service/product; and
(d) receiving payment from the proceeds of the sale.

33. The landscaping service/product marketing method of claim 32, which includes receiving payment for the service/product from another source of funds upon an event selected from the group consisting of: the owner no longer offering the real estate for sale, the owner not selling the real estate in a specified time period and the owner changing realtors.

34. A landscaping service/product marketing method comprising the steps of:
(a) estimating an amount of additional money a real estate owner can make through a sale of real estate if a landscaping service/product is performed prior to the sale;
(b) quoting a price to the owner for the service/product that is below the amount;
(c) providing the landscaping service/product; and
(d) subtracting the quoted price from proceeds achieved from the sale.

35. The landscaping service/product marketing method of claim 34, wherein at least one of the steps of estimating the amount and quoting the price is performed by a realtor.

36. A real estate marketing method comprising the steps of:
offering to sell an owner's real estate; and
providing an option to the owner to improve the real estate to achieve a higher sale price for the real estate, wherein the owner pays for the improvement out of proceeds received from a sale of the real estate.

37. The real estate marketing method of claim 36, which includes the step of obtaining a provider of the improvement, wherein the provider receives at least a portion of the payment for the improvement.

38. The real estate marketing method of claim 36, which includes the step of enabling a provider of the improvement to contract with the owner, wherein the provider receives at least a portion of the payment for the improvement.

39. The real estate marketing method of claim 36, wherein the improvement is selected from the group consisting of: landscaping (including sod laying, seeding, mulching, edging, grading, leveling or berm building, weeding, planting of trees, shrubs or plants/flowers, installation of ponds, rock walls, waterfalls or sprinkler systems), interior or exterior painting, wallpapering, siding or installation of stucco, brick or stone exterior or interior walls, installing hardwood or other type of flooring, installing, repairing or replacing fireplaces, carpeting, tiling, remodeling or home additions (including separate dwellings such as coach houses or detached garages), plumbing, roofing, tuck pointing, window replacement, installation or repair, pest control, drainage equipment installation or repair, installation of a Jacuzzi, whirlpool or hot tub, replacement or new installation of fixtures, upgrading vanities, toilets, bathroom or kitchen countertops, decking replacement, repair or installation, driveway/walkway installation, repair or replacement, and any combination thereof.

40. The real estate marketing method of claim 36, which is provided via a computer program on a computer storage device, data network or internet.

41. A real estate marketing method comprising the steps of:
enabling an owner of real estate to make an improvement to the real estate before a sale of the real estate and to defer payment for the improvement until the sale occurs; and
receiving a higher commission from the sale based on an increased sale price due to the improvement.

42. The real estate marketing method of claim 41, which includes the step of estimating the increased sale price for the owner and obtaining a cost for the improvement that is lower than the increase in price.

43. The real estate marketing method of claim 41, which includes additionally receiving a portion of the deferred payment for the improvement.

44. A real estate collateral lending method comprising the steps of
performing an appraisal for a piece of real estate assuming the real estate to be in an improved condition relative to a current condition; and
lending an amount of money to an owner of the real estate, the amount based on the appraisal for the improved real estate, and wherein a portion of the amount is designated to pay for placing the real estate in the improved condition.

45. The real estate collateral lending method of claim 44, which includes selecting a provider of an improvement needed to place the real estate in the improved condition.

46. The real estate collateral lending method of claim 44, which includes facilitating a contract between the owner and a provider of an improvement needed to place the real estate in the improved condition.

47. The real estate collateral lending method of claim 46, wherein the contract specifies that the provider be paid by the owner from another source of funds if a loan is not transacted.

48. The real estate collateral lending method of claim 44, which is provided via a computer program on a computer storage device, data network or internet.

49. The real estate collateral lending method of claim 44, wherein the improved condition is selected from the group consisting of: landscaping (including sod laying, seeding, mulching, edging, grading, leveling or berm building, weeding, planting of trees, shrubs or plants/flowers, installation of ponds, rock walls, waterfalls or sprinkler systems), interior or exterior painting, wallpapering, siding or installation of stucco, brick or stone exterior or interior walls, installing hardwood or other type of flooring, installing, repairing or replacing fireplaces, carpeting, tiling, remodeling or home additions (including separate dwellings such as coach houses or detached garages), plumbing, roofing, tuck pointing, window replacement, installation or repair, pest control, drainage equipment installation or repair, installation of a Jacuzzi, whirlpool or hot tub, replacement or new installation of fixtures, upgrading vanities, toilets, bathroom or kitchen countertops, decking replacement, repair or installation, driveway/walkway installation, repair or replacement, and any combination thereof.

50. The real estate collateral lending method of claim 44, wherein the amount of money is lent as part of a refinance, home equity loan or additional mortgage.

51. A real estate collateral lending method comprising the steps of:
enabling an owner of real estate to make an improvement to the real estate before a loan is funded using the real estate as collateral and to defer payment for the improvement until funding occurs; and
receiving a higher fee from the loan based on an increased loan amount due to the improvement.

52. The real estate collateral lending method of claim 51, which includes facilitating a bid for a cost of the improvement from a provider of the improvement, wherein the provider is paid from the funding of the loan.

53. The real estate collateral lending method of claim 51, wherein at least one of the steps of estimating the amount and quoting the price is performed by a realtor.

54. The real estate collateral lending method of claim 51, which is provided via a computer program on a computer storage device, data network or internet.
